(19) United States
(12) Patent Application Publication
(10) Pub. No.: US 2024/0237685 A1
(43) Pub. Date: Jul. 18, 2024

(54) EGG ANALOGUE PRODUCT

(71) Applicant: SOCIETE DES PRODUITS NESTLE S.A., Vevey (CH)

(72) Inventors: ANTOINE CROS, Lussery-Villars (CH); ISABEL FERNANDEZ FARRES, Barcelona (ES); FANNY LAZZARO, Lausanne (CH); PATRICK PIBAROT, Territet (CH); LAURA HERZ, Lausanne (CH); EDWIN ALBERTO HABEYCH NARVAEZ, Lausanne (CH); YVETTE FLEURY REY, Ursy (CH); JANNIKA DOMBROWSKI, Lausanne (CH)

(21) Appl. No.: 18/559,143

(22) PCT Filed: May 6, 2022
(86) PCT No.: PCT/EP2022/062318

§ 371 Date: Nov. 6, 2023

(30) Foreign Application Priority Data
May 7, 2021 (EP) 21172827.4
Nov. 8, 2021 (EP) 21206980.1

(51) Int. Cl. A23L 15/00; A23J 3/16; A23L 29/256

(52) U.S. Cl. CPC A23L 15/35; A23J 3/16; A23L 29/256

(57) ABSTRACT

The present invention relates to a vegan egg analogue product, said product comprising an emulsion having between 10 to 43 wt. %, preferably between 15 to 40 wt. % legume protein on a dry basis, between 50 to 85 wt. %, preferably between 58 to 81 wt. % vegetable fat on a dry basis, and optionally between 0.02 to 10 wt. % of a polysaccharide on a dry basis, wherein said legume protein is preferably soy protein isolate, and wherein said emulsion has a fat to protein ratio of between 1.2 to 8.5, preferably between 1.5 to 3.0.

### INTRODUCTION

Demand for plant-based products has grown significantly in recent years across many food categories and applications. This trend has been driven by many factors including allergenicity, sustainability, animal welfare, and consumer shifts towards more “flexitarian” diets.

Egg is one of the most common source of food allergens. For example, egg allergies affect an estimated 0.5-2.5% of young children, with symptoms ranging from mild rash to anaphylaxis (Rona et al. 2007).

The sustainability of egg production has been widely studied. Research has shown that greenhouse gas emissions averaged a global warming potential of 2.2 kg of CO₂ equivalent per dozen eggs. One kilogram of protein from free-range eggs produces 0.2 kg of CO₂ equivalent. Of these emissions, 63% represent embodied carbon in poultry feed (Taylor et al., 2014).

The main public concern with egg production and consumption is the welfare of the chickens needed to produce the huge amount of eggs consumed. While it is difficult to quantify chicken welfare in the egg industry, a number of objective indicators have been identified and are commonly used, including area available per chicken and bone fractures. (Cleveland et al., 2021).

The ongoing transition towards greener and healthier diets in western countries is paving the way for the development of mixed egg/plant innovative foods to meet the demands of new “flexitarian” consumers and the increasing proportion of vegetarians (Guyomarch et al., 2020).

Plant based egg analogue products therefore represent a great opportunity to help address the abovementioned concerns. However, most products currently on the market either do not perform in a sufficiently similar way to real egg in final applications, or they contain many unnatural additives and so do not meet consumer expectations with regard to the need for a clean label ingredient list.

### SUMMARY OF INVENTION

The present application describes a superior egg analogue product which performs like real chicken egg in final applications and has a short ingredient list.

In a first aspect, the invention relates to an egg analogue product, preferably a vegan egg analogue product, said product comprising an emulsion having between 10 to 43 wt. %, preferably between 15 to 40 wt. % legume protein on a dry basis, between 50 to 85 wt. %, preferably between 58 to 81 wt. % vegetable fat on a dry basis, and optionally between 0.02 to 10 wt. % of a polysaccharide on a dry basis, wherein said legume protein is preferably soy protein isolate, and wherein said emulsion has a fat to protein ratio of between 1.2 to 8.5, preferably between 1.5 to 3.0.

In a second aspect, the invention relates to an egg analogue product, preferably a vegan egg analogue product, said product comprising an emulsion of 5-20 wt. % legume protein, preferably a soy or pea protein isolate, 3-50 wt. % vegetable fat, optionally 0.01 wt. %-5 wt. % of a polysaccharide, and 50-90 wt. % water.

In a third aspect, the invention relates to a method of making an egg analogue product, said method comprising
a. Hydrating a legume protein, preferably a soy protein isolate;
b. Optionally dispersing a polysaccharide; and
C. Adding oil and emulsifying, for example by homogenization, to form an emulsion.

In a fourth aspect, the invention relates to an egg analogue product according to the invention for use as a whole egg replacement in a cooked in pan egg application, in sauces, or in baked products.

### BRIEF DESCRIPTION OF THE FIGURES

FIG. 1 shows a comparison of prototype M versus chicken egg when measured for texture by sensory assessment in scrambled egg application.

FIG. 2 shows the relationship between the D₉₀ of the particle size distribution of several soy protein-based emulsion prototypes and their respective oiliness, relative to that of chicken egg, when cooked in scrambled egg application.

FIG. 3 shows the relationships between averaged values of several texture parameter (A. Rubbery, B. Compact and C. Chewy) for each pH group of the soy protein-based emulsion prototypes relative to chicken egg when cooked in scrambled egg application.

FIG. 4 shows the increase of G′ and G′ of the potato protein dispersion on heating by several orders of magnitude.

FIG. 5 shows the soy protein-based emulsion prototypes used in several common egg applications (A, egg white analogue in sunny side up/vegan tube applications; and egg analogue cooked either as scrambled egg (B), or used in egg free cake (C), or used as binder in vegetable patty (D).

FIG. 6 shows the relationship between the protein content on a dry basis (% dry matter basis, % DMB) of several soy protein isolate-based emulsion prototypes and their respective sensory attributes (firm, moist and chewy) relative to chicken egg when cooked in scrambled egg application.

FIG. 7 shows the relationship between the fat content in % dry matter basis (% DMB) of several soy protein isolate-based emulsion prototypes and their respective sensory attributes (firm, moist and chewy) relative to chicken egg when cooked in scrambled egg application.

FIG. 8 shows the relationship between the fat/protein ratio of several soy protein isolate-based emulsion prototypes and their respective sensory attributes (firm, moist and chewy) relative to chicken egg when cooked in scrambled egg application.

FIG. 9 shows the relationship between the heat treatment conditions applied to the prototypes and their respective firmness, moistness, chewiness, rubberiness, compactness, crumbliness and stickiness relative to that of chicken egg when cooked in scrambled egg application.

FIG. 10 shows the relationship between the D₉₀ of the particle size distribution of several soy protein-based emulsion prototypes and their respective firmness, moistness and chewiness, relative to that of chicken egg, when cooked in scrambled egg application.

FIG. 11 shows the relationship between the pH of several soy protein isolate-based emulsion prototypes and their respective sensory attributes (firm, moist and chewy) relative to chicken egg when cooked in scrambled egg application.

### EMBODIMENTS OF THE INVENTION

### Egg Analogue Product

The invention relates in general to an egg analogue product.

Preferably, the invention relates to a vegan egg analogue product.

In one embodiment, the vegan egg analogue product comprises plant protein, and vegetable fat.

Preferably, the product comprises legume protein, and vegetable fat.

Preferably, the product comprises an emulsion of legume protein, preferably a soy protein isolate, vegetable fat, and optionally a polysaccharide.

Preferably, the product comprises an emulsion having at least 10 wt. % legume protein on a dry basis, at least 50 wt. % vegetable fat on a dry basis, and optionally at least 0.02 wt. % of a polysaccharide on a dry basis, wherein said legume protein is preferably soy protein isolate, and wherein said emulsion has a fat to protein ratio of at least 1.2.

Preferably, the product comprises an emulsion having up to 43 wt. % legume protein on a dry basis, up to 85 wt. % vegetable fat on a dry basis, and optionally up to 10 wt. % of a polysaccharide on a dry basis, wherein said legume protein is preferably soy protein isolate, and wherein said emulsion has a fat to protein ratio of up to 8.5.

Preferably, the product comprises an emulsion having between 10 to 43 wt. % legume protein on a dry basis, between 50 to 85 wt. % vegetable fat on a dry basis, and optionally between 0.02 to 10 wt. % of a polysaccharide on a dry basis, wherein said legume protein is preferably soy protein isolate, and wherein said emulsion has a fat to protein ratio of between 1.2 to 8.5.

Preferably, the product comprises an emulsion having between 15 to 40 wt. % legume protein on a dry basis, between 58 to 81 wt. % vegetable fat on a dry basis, and optionally between 0.02 to 10 wt. % of a polysaccharide on a dry basis, wherein said legume protein is preferably soy protein isolate, and wherein said emulsion has a fat to protein ratio of between 1.5 to 3.0.

In one embodiment, said emulsion has a fat to protein ratio of between 2.5 to 3.0.

In one embodiment, the vegan egg analogue product comprises plant protein, vegetable fat, and water.

Preferably, the product comprises legume protein, vegetable fat, and water.

Preferably, the product comprises an emulsion of legume protein, preferably a soy or pea protein isolate, vegetable fat, optionally a polysaccharide, and water.

Preferably, the product comprises an emulsion of at least 5 wt. % legume protein, preferably a soy or pea protein isolate, at least 3 wt. % vegetable fat, optionally at least 0.01 wt. % of a polysaccharide, and at least 50 wt. % water.

Preferably, the product comprises an emulsion of up to 20 wt. % legume protein, preferably a soy or pea protein isolate, up to 50 wt. % vegetable fat, optionally up to 5 wt. % of a polysaccharide, and up to 90 wt. % water.

Preferably, the product comprises an emulsion of 5-20 wt. % legume protein, preferably a soy or pea protein isolate, 3-50 wt. % vegetable fat, optionally 0.01-5 wt. % of a polysaccharide, and 50-90 wt. % water.

In one embodiment, the product has a pH range between 6 to 9.

In one embodiment, the product has a pH range between 7 to 9.

In one embodiment, the product has a pH range between 6.7 to 8.6.

In one embodiment, the product has a D₉₀ emulsion droplet size less than 10 microns measured by image analysis. In one embodiment, the product has a D₉₀ emulsion droplet size less than 5 microns measured by image analysis. In one embodiment, the product has a D₉₀ emulsion droplet size between 1.5 to 2.5 microns measured by image analysis. In one embodiment, the product has a D₉₀ emulsion droplet size between 1.7 to 2.5 microns, measured by image analysis.

In one embodiment, the product is able to form a gel upon heating to a temperature of between 70° C. and 150° C., preferably between 100° C. and 130° C.

In one embodiment, the polysaccharide is a seaweed or a seaweed extract, preferably a carrageenan containing seaweed or seaweed extract.

In one embodiment, the polysaccharide is carrageenan, preferably a kappa-carrageenan.

In one embodiment, the polysaccharide is starch.

In one embodiment, the polysaccharide is methylcellulose or a methylcellulose derivative.

In one embodiment, the product further comprises a plant protein having a G′ value between 3500 and 4000 Pa, and G′ value between 400 and 500 Pa at 60° C. after heating to 90° C. at a protein concentration of 8% wt. measured at 1 Hz and 0.5% shear strain, wherein the plant protein is preferably a potato protein isolate.

In one embodiment, the product further comprises transglutaminase, for example between 0.01 to 0.5 wt. % transglutaminase.

In one embodiment, the product has a viscosity below 2200 mPa·s−1 at 25° C. under 160 rpm shear.

In one embodiment, the product when cooked has between 60-100% of the texture attributes of a cooked egg. In one embodiment, the product when cooked has the rubbery texture attribute of a cooked egg. In one embodiment, the product when cooked has the chewy texture attribute of a cooked egg. In one embodiment, the product when cooked has the moist texture attribute of a cooked egg. In one embodiment, the product when cooked has the oiliness texture attribute of a cooked egg.

In one embodiment, the legume protein is a soy protein isolate.

In one embodiment, the legume protein is a pea protein isolate.

### Method of Making an Egg Analogue Product

The invention further relates to a method of making a vegan egg analogue product, said method comprising
a. Hydrating a plant protein, preferably a legume protein, more preferably a soy protein isolate;
b. Optionally dispersing a polysaccharide; and
c. Adding oil and emulsifying, for example by homogenization, to form an emulsion.

Preferably, the oil is vegetable fat.

In one embodiment, the emulsion comprises at least 10 wt. % legume protein on a dry basis, at least 50 wt. % vegetable fat on a dry basis, and optionally at least 0.02 wt. % of a polysaccharide on a dry basis, wherein said legume protein is preferably soy protein isolate, and wherein said emulsion has a fat to protein ratio of at least 1.2.

Preferably, the emulsion comprises up to 43 wt. % legume protein on a dry basis, up to 85 wt. % vegetable fat on a dry basis, and optionally up to 10 wt. % of a polysaccharide on a dry basis, wherein said legume protein is preferably soy protein isolate, and wherein said emulsion has a fat to protein ratio up to 8.5.

Preferably, the emulsion comprises between 10 to 43 wt. % legume protein on a dry basis, between 50 to 85 wt. % vegetable fat on a dry basis, and optionally between 0.02 to 10 wt. % polysaccharide on a dry basis, wherein said legume protein is preferably soy protein isolate, and wherein said emulsion has a fat to protein ratio of between 1.2 to 8.5.

In one embodiment, the emulsion comprises at least 5 wt. % legume protein, preferably a soy protein isolate, at least 3 wt. % vegetable fat, optionally at least 0.01 wt. % of a polysaccharide, and at least 50 wt. % water.

Preferably, the emulsion comprises up to 20 wt. % legume protein, preferably a soy protein isolate, up to 50 wt. % vegetable fat, optionally up to 5 wt. % of a polysaccharide, and up to 90 wt. % water.

Preferably, the emulsion comprises 5-20 wt. % legume protein, preferably a soy protein isolate, 3-50 wt. % vegetable fat, optionally 0.01-5 wt. % of a polysaccharide, and 50-90 wt. % water.

In one embodiment, the D₉₀ emulsion droplet size is less than 10 microns, preferably less than 5 microns, preferably between 1.5 to 2.5 microns, measured by image analysis.

In one embodiment, the method further comprises heating the emulsion to at least 50° C., adding methylcellulose and/or a methylcellulose derivative to the emulsion, followed by cooling the emulsion.

In one embodiment, the product is able to form a gel upon heating to a temperature of between 70° C. and 150° C., preferably between 100° C. and 130° C.

In one embodiment, the polysaccharide is a seaweed or a seaweed extract, preferably a carrageenan containing seaweed or seaweed extract.

In one embodiment, the polysaccharide is carrageenan, preferably a kappa-carrageenan.

In one embodiment, the polysaccharide is starch.

In one embodiment, the polysaccharide is methylcellulose or a methylcellulose derivative.

In one embodiment, the product further comprises transglutaminase, for example between 0.01 to 0.5 wt. % transglutaminase.

In one embodiment, heat is applied to the emulsion at greater than atmospheric pressure, for example greater than 20 bar, or between 20 bar to 400 bar.

In one embodiment, the legume protein is a soy protein isolate.

In one embodiment, the legume protein is a pea protein isolate.

In one embodiment, heat is applied to the emulsion, for example by steam injection. The emulsion can be heat treated by direct steam injection, for example to at least at about 91° C. The emulsion can be cooled down, for example to reach a temperature of about 10° C.

In one embodiment, heat is applied to the emulsion by steam injection at greater than atmospheric pressure.

In one embodiment, the emulsion is homogenized using a high-pressure homogenizer, for example at a pressure of at least 30 bars, or 200 bars, or 400 bars.

In one embodiment, the emulsion further comprises colours and/or flavouring agent.

The invention further relates to an egg analogue product, preferably a liquid egg analogue product, made by a method according to the invention.

The invention further relates to an egg analogue product according to the invention for use as a whole egg replacement, for example a whole egg replacement in a cooked in pan egg application, for example as scrambled egg, in sauces, or in baked products.

The invention further relates to an egg analogue product according to the invention for use as a binder.

The invention further relates to an egg analogue product according to the invention for use as an egg tube, or as a sunny side up egg.

The invention further relates to the use of plant protein, more preferably a legume protein, more preferably a soy protein isolate based emulsion to make a vegan egg analogue product.

### DETAILED DESCRIPTION OF THE EMBODIMENTS

### Egg Analogue Product

The egg analogue product is vegan. The egg analogue product can be a liquid, paste, semi-solid or solid. Preferably, the egg analogue product is a liquid. Preferably, the egg analogue product comprises water.

### Plant Protein

The egg analogue product comprises a plant protein. The plant protein can be a legume protein, an oilseed protein, a cereal protein, wherein the cereal protein is preferably a rice protein or a wheat protein. The oilseed protein can be a canola protein. Preferably, the egg analogue product comprises a legume protein. The protein can be a flour, concentrate, or isolate, preferably an isolate. Preferably, the legume protein is a soy protein, preferably a soy protein isolate.

In one embodiment, the egg analogue product comprises at least 10 wt. %, at least 11 wt. %, at least 12 wt. %, at least 13 wt. %, at least 14 wt. %, or at least 15 wt. % plant protein on a dry basis. The egg analogue product preferably comprises up to 43 wt. %, up to 42 wt. %, up to 41 wt. % or up to 40 wt. % plant protein on a dry basis. The egg analogue product preferably comprises between 10 to 43 wt. % plant protein, between 11 to 42 wt. % plant protein, between 12 to 41 wt. % wt. % plant protein, between 13 to 40 wt. % plant protein, between 14 to 40 wt. % plant protein, or between 15 to 40 wt. % plant protein on a dry basis.

In one embodiment, the egg analogue product comprises at least 5 wt. %, at least 6 wt. %, at least 7 wt. %, at least 8 wt. %, or at least 9 wt. % plant protein. The egg analogue product preferably comprises up to 15 wt. %, up to 16 wt. %, up to 17 wt. %, up to 18 wt. %, up to 19 wt. %, or up to 20 wt. % plant protein. The egg analogue product preferably comprises between 5 to 20 wt. % plant protein, between 6 to 19 wt. % plant protein, between 7 to 18 wt. % plant protein, between 8 to 17 wt. % plant protein, between 9 to 16 wt. % plant protein, or between 10 to 15 wt. % plant protein.

### Vegetable Fat

In the context of the present invention, the term fat refers to triglycerides. Fats which are generally encountered in their liquid form are commonly referred to as oils. In the present invention the terms oils and fats are interchangeable. The vegetable fat can be liquid or solid. Preferably, the vegetable fat is liquid. The vegetable fat can be, for example, canola oil, olive oil, sunflower oil. The vegetable fat is preferably canola oil.

In one embodiment, the egg analogue product comprises at least 50 wt. % vegetable fat, at least 51 wt. % vegetable fat, at least 52 wt. % vegetable fat, at least 53 wt. % vegetable fat, at least 54 wt. % vegetable fat, at least 55 wt. % vegetable fat, at least 56 wt. %, at least 57 wt. % vegetable fat or at least 58 wt. % vegetable fat on a dry basis. The egg analogue product preferably comprises up to 85 wt. % vegetable fat, up to 84 wt. % vegetable fat, up to 83 wt. % vegetable fat, up to 82 wt. % vegetable fat, or up to 81 wt. % vegetable fat on a dry basis.

In one embodiment, the egg analogue product comprises at least 3 wt. % vegetable fat, at least 4 wt. % vegetable fat, at least 5 wt. % vegetable fat, at least 6 wt. % vegetable fat, at least 7 wt. % vegetable fat, or at least 8 wt. % vegetable fat. The egg analogue product preferably comprises up to 25 wt. % vegetable fat, up to 26 wt. % vegetable fat, up to 27 wt. % vegetable fat, up to 28 wt. % vegetable fat, up to 29 wt. % vegetable fat, or up to 25 wt. % vegetable fat.

### Legume Protein

The legume protein can be from a legume plant selected from the family Fabaceae. The legume plant may belong to the genus Glycine, for example Glycine max. The legume plant may belong to the genus Pisum, for example Pisum sativum. The legume plant may belong to the genus Vigna, for example Vigna angularis. The legume plant may belong to the genus Phaseolus, for example Phaseolus vulgaris. The legume plant may belong to the genus Vicia, for example Vicia faba. The Glycine max plant can be soybean. The Pisum sativum plant can be pea.

The legume protein may be a pea protein, for example a pea protein isolate. The legume protein is preferably a soy protein, preferably a soy protein isolate.

### Emulsion Droplet Size

The emulsion droplet size of the product is preferably less than 10 microns, preferably less than 5 microns, preferably between 1.5 to 2.5 microns, measured by image analysis.

### Egg Analogue Product Recipes

The product preferably comprises an emulsion of 5-20 wt. % legume protein, preferably a soy or pea protein isolate, 3-50 wt. % vegetable fat, preferably 5-30 wt. % vegetable fat, optionally 0.01-5 wt. % of a polysaccharide, and 50-90 wt. % water. The pH may be between 6 to 9.

For example, the product may comprise an emulsion of 6-13 wt. % soy protein isolate, 16-28 wt. % vegetable fat, and 64-73 wt. % water. The pH may be 7 to 9.

The product may comprise a recipe similar to that shown in the examples section herein. The product may comprise an emulsion of about 6.2 wt. % soy protein isolate, about 26.4 wt. % fat, about 67.4 wt. % water, and pH of about 8. The product may comprise an emulsion of about 8.3 wt. % soy protein isolate, about 25.2 wt. % fat, about 66.6 wt. % water, and pH about 9. The product may comprise an emulsion of about 8.6 wt. % soy protein isolate, about 19.1 wt. % fat, about 72.2 wt. % water, and pH about 7. The product may comprise an emulsion of about 12.4 wt. % soy protein isolate, about 22.8 wt. % fat, about 64.8 wt. % water, and pH about 8. The product may comprise an emulsion of about 9.5 wt. % soy protein isolate, about 21.6 wt. % fat, about 69.0 wt. % water, and pH about 8. The product may comprise an emulsion of about 12.5 wt. % soy protein isolate, about 19.8 wt. % fat, about 67.7 wt. % water, and pH about 7. The product may comprise an emulsion of about 6.7 wt. % soy protein isolate, about 27.6 wt. % fat, about 65.3 wt. % water, and pH about 7.4.

In each case, the emulsion can have a fat droplet particle size distribution with a D₉₀ of less than 10 microns. The emulsion can be heat treated by direct steam injection, for example at about 91° C. for about 10 mins. The emulsion can be cooled down, for example to reach a temperature of about 10° C., for example in less than 2 hours.

### Use as Egg Replacer

In some embodiments, the compositions can be used as a replacement for whole eggs, egg yolks, or egg whites in food products. In some embodiments, the food products can be baked goods such as but not limited to cakes, brownies, cookies, pancakes, pastries, pies, tarts, and scones. In some embodiments, the compositions can be used as a replacement for eggs or egg parts in other products such as but not limited to pasta, noodles, meatloaf, burgers, custards, sauces, ice cream, mayonnaise, and/or salad dressings.

The product can be used in many culinary applications, for example for aerating (e.g. in sponge cakes, soufflés, pavola), binding (e.g. in hamburgers, patties, omelettes, quenelles), clarifying (e.g. in stocks, consommé soups, aspic), coating (e.g. fried or deep fried foods, such as fish, meats, chicken and vegetables), enriching (e.g. cakes, puddings, pasta, egg-nog drinks), garnishing (e.g. consommé royal, consommé celestine), glazing (e.g. bread and bread rolls, duchesse potatoes), or for thickening (e.g. soups, custards).

### Definitions

When a composition is described herein in terms of wt. %, this means a mixture of the ingredients on a moisture free basis, unless indicated otherwise.

As used herein, the term “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range.

As used herein, the term “analogue” is considered to be an edible substitute of a substance in regard to one or more of its major characteristics. An “egg analogue” as used herein is a substitute of egg in the major characteristics of purpose and usage. Preferably, the egg analogue is an analogue of chicken egg. Preferably, the egg analogue is a substitute of chicken egg and is statistically similar, or has to within 60-100% to the texture of chicken egg, for example statistically similar rubbery, or moist, or chewy, or compact, or crumbly texture of chicken egg.

As used herein, the term “vegan” refers to an edible composition which is entirely devoid of animal products, or animal derived products, for example eggs, milk, honey, fish, and meat.

As used herein, the term “vegetarian” relates to an edible composition which is entirely devoid of meat, poultry, game, fish, shellfish or by-products of animal slaughter.

As used herein, the term “liquid” relates to a product which has a viscosity below 2200 mPa·s−1 at 25° C. under 160 rpm shear.

As used herein, the term polysaccharide relates to a type of carbohydrate. A polysaccharide is a polymer comprising chains of monosaccharides that are joined by glycosidic linkages. Polysaccharides are also known as glycans. By convention, a polysaccharide consists of more than ten monosaccharide units. Polysaccharides may be linear or branched. They may consist of a single type of simple sugar (homopolysaccharides) or two or more sugars (heteropolysaccharides). The main functions of polysaccharides are structural support, energy storage, and cellular communication. Examples of polysaccharides include carrageenan, cellulose, hemicellulose, chitin, chitosan, glycogen, starch, dextrin (starch gum), hyaluronic acid, polysdextrose, inulin, beta-glucan, pectin, psyllium husk mucilage, beta-mannan, carob, fenugreek, guar gum tara gum, konjac gum or glucomannan, gum acacia (arabic), karaya, tragacanth, arabinoxylan, gellan, xanthan, agar, alginate, methylcellulose, carboxymethylcelulose, hydroxypropyl methylcellulose, microfibrilated cellulose, microcrystalline cellulose.

As used herein, a “protein isolate” comprises at least 70 wt. % protein, more preferably at least 80 wt. % protein, or about 84 wt. % protein.

Those skilled in the art will understand that they can freely combine all features of the present invention disclosed herein. In particular, features described for the compositions of the present invention may be combined with the method or uses of the present invention and vice versa. Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### EXAMPLES

### Example 1

### Egg Analogue Compositions and Recipes

Three different set of emulsion prototypes were manufactured following slightly different procedures. Each set of prototypes is identified by a specific coding to account for these differences, i.e., A to M, T1 to T18 and V1 to V6.

In total thirty-seven emulsion prototypes (prototypes A to M; T1 to T18; V1 to V6) were made using soy protein isolate (with at least 84 wt. % protein content), canola oil as fat source, water, and natural colorant and flavor for variant V1 to V6.

Soy protein isolate was hydrated in water under mixing at room temperature for variants A to M and T1 to T18, and at 65° C. for variant V1 to V6. Either KOH or HCl (1M) was added to adjust pH if needed. The mixture was further mixed under the same conditions to ensure proper dispersion of the soy protein isolate. For the emulsification step, oil was added and mixed to form a fine emulsion with a fat droplet particle size distribution with a D₉₀ of less than 10 microns. The emulsion was then heat treated, except for variant V1:

1) At atmospheric pressure:
a. prototypes T1 to T18: at a product temperature of 70-80° C. for at least 2 min, in a heating mixer,
b. prototypes A to M and V2: at a product temperature of 90° C. for 10 mins, in a heating mixer.

2) At pressure greater than atmospheric pressure:
a. prototypes V3 to V6: at 141ºC for 5 see, at 6 bars in a UHT sterilization system.

For some variants, the emulsion was subsequently treated with different downstream homogenization pressures using a high-pressure homogenizer, i.e. 30 bars, 200 bars and 400 bars for V4, V5 and V6 respectively. V3 was not subjected to downstream homogenization (0 bar).

The emulsion was then cooled down to 6° C.

The prototypes were cooked in pan as scrambled egg. An induction cooker (UNOLD AG 58105, Hockenheim, Germany) was set to 1600 W and used to pre heat a 26 cm diameter frying pan for 30 sec. 500 g of product was then poured and stirred continuously until the desired scrambled egg aspect was obtained, i.e. fully solidified and slightly roasted.

Regarding the chicken egg reference, approximately 9 eggs were beaten manually using a whisk until the yolks and whites were mixed homogeneously (the homogeneity was checked visually). 500 g of this mixture was weighed and cooked following the procedure described above.

Sensory evaluation of cooked chicken eggs and prototypes was performed with untrained panelists (n=8), that received no specific training on the use of the intensity scales and were naïve to the egg prototypes. They were asked to perform Rate All That Apply (RATA) sensory methodology (Ares et al., Food Quality and Preference, 2014, 36, 87-95). A four-category scale was used with, from left to right, “slightly”, “moderately”, “very” and “extremely” as verbal labels with corresponding scoring equal to 1, 2, 3 and 4, respectively, while no tick was equal to “0”, corresponding to a non perceived attribute.

Panelists used the glossary shown in Table 1. Data were collected using EyeQuestion® software (Logic 8, Elst, the Netherlands) in individual sensory booths. For each conducted sensory session, cooked chicken eggs were included as part of the set of assessed samples. When indicated, the scores of the texture attributes for the prototypes are expressed in percentage, relatively to the score obtained for the same attribute with cooked chicken eggs:

$${score}_{relative} = s c o r {e}_{prototype} / {score}_{chicken egg} * 100$$

TABLE 1

| Texture | |
|---|---|
| attribute | Description |
| Rubbery | Effort required to compress the product by applying a force persistently and |
| | repeatedly with little result (rubbery products are elastic/springy). |
| Moist | Extent to which the product feels moist while chewing. |
| Chewy | The time required to masticate sample to a consistency acceptable for swallowing |
| Compact | Dense and heavy texture resulting from a lack of air in the product. Opposite: |
| | aerated (aerated to compact) |
| Crumbly | Extent to which the product falls apart into many pieces/crumbs on first bite. |
| Oily | Describes the perception of an oily film coating/enrobing the mouth. |
| Firm | The amount of force needed to deform the sample by first biting with incisors, |
| | then chewing with molars. |
| Sticky | Extent to which the product sticks to the teeth or palate during biting and |
| | chewing or during movement in the mouth. |

Samples were identified using a 3-digit random code. Sensory evaluation was performed under red light to neutralize the impact of color variation among samples on texture assessment during the tasting. To avoid saturation effect, a maximum of 7 products were evaluated for each single session with 2 minutes pause between the samples during which 5 panelists were provided with freshly opened Acqua Panna water as palate cleaner.

Table 2 shows the macronutrient compositions and pH values of soy-based emulsion prototypes that can be used as chicken egg replacer. Overall performance in terms of texture properties in scrambled egg application are reported compared to chicken egg in the last column. The overall texture performance was defined as “++” and “+” if among the 8 sensory attributes tested, at least 6, and 3, respectively were falling within the 60-100% range of the sensory average intensity determined for the chicken egg reference. Otherwise, the overall texture performance was defined as “−”.

TABLE 2

| | | | | | Fat to | Overall |
|---|---|---|---|---|---|---|
| | g/100 g | g/100 g | g/100 g | | protein | Texture |
| | Protein | Fat | Water | pH | ratio | Performance |
| Chicken egg | 12.6 | 9.5 | 76.4 | | 0.75 | ++ |
| Prototype A | 6.2 | 26.4 | 67.4 | 8.0 | 4.26 | + |
| Prototype B | 6.6 | 20.3 | 73.1 | 7.0 | 3.08 | − |
| Prototype C | 7.9 | 17.1 | 75.0 | 9.0 | 2.16 | − |
| Prototype D | 7.1 | 28.8 | 64.1 | 7.0 | 4.06 | − |
| Prototype E | 9.1 | 27.6 | 63.3 | 9.0 | 3.03 | − |
| Prototype F | 9.8 | 15.5 | 74.7 | 8.0 | 1.58 | + |
| Prototype G | 8.3 | 25.2 | 66.6 | 9.0 | 3.04 | + |
| Prototype H | 8.6 | 19.1 | 72.2 | 7.0 | 2.22 | + |
| Prototype I | 12.4 | 22.8 | 64.8 | 8.0 | 1.84 | + |
| Prototype J | 12.8 | 16.7 | 70.5 | 6.0 | 1.30 | + |
| Prototype K | 9.5 | 21.6 | 69.0 | 8.0 | 2.27 | + |
| Prototype L | 12.5 | 19.8 | 67.7 | 7.0 | 1.58 | + |
| Prototype M | 6.7 | 27.6 | 65.3 | 7.4 | 4.12 | + |
| Prototype T1 | 5 | 20 | 74.19 | 7.2 | 4.00 | − |
| Prototype T2 | 5 | 14.29 | 79.90 | 7.3 | 2.86 | + |
| Prototype T3 | 5 | 8.33 | 85.85 | 7.4 | 1.67 | − |
| Prototype T4 | 5 | 5.88 | 88.30 | 7.4 | 1.18 | − |
| Prototype T5 | 5 | 5 | 89.10 | 7.3 | 1.00 | − |
| Prototype T6 | 4 | 4.44 | 90.90 | 7.4 | 1.11 | − |
| Prototype T7 | 10 | 0 | 88.37 | 7.3 | 0.00 | + |
| Prototype T8 | 9 | 25.71 | 63.82 | 7.3 | 2.86 | + |
| Prototype T9 | 2 | 5.71 | 91.96 | 7.4 | 2.86 | − |
| Prototype T10 | 6.5 | 18.57 | 73.87 | 6.1 | 2.86 | ++ |
| Prototype T11 | 6.5 | 18.57 | 73.87 | 6.7 | 2.86 | + |
| Prototype T12 | 6.5 | 18.57 | 73.87 | 7.1 | 2.86 | + |
| Prototype T13 | 6.5 | 18.57 | 73.87 | 7.6 | 2.86 | + |
| Prototype T14 | 6.5 | 18.57 | 73.87 | 8.0 | 2.86 | + |
| Prototype T15 | 6.5 | 18.57 | 73.87 | 8.6 | 2.86 | − |
| Prototype T16 | 6.5 | 18.57 | 73.87 | 9.0 | 2.86 | − |
| Prototype T17 | 6.5 | 18.57 | 73.87 | 9.5 | 2.86 | − |
| Prototype T18 | 6.5 | 18.57 | 73.87 | 10.1 | 2.86 | − |
| Prototype V1 | 8 | 22.44 | 66.63 | 6.9 | 2.81 | − |
| Prototype V2 | 8 | 22.44 | 66.63 | 6.9 | 2.81 | + |
| Prototype V3 | 8 | 22.44 | 66.63 | 6.9 | 2.81 | ++ |
| Prototype V4 | 8 | 22.44 | 66.63 | 7 | 2.81 | ++ |
| Prototype V5 | 8 | 22.44 | 66.63 | 7 | 2.81 | ++ |
| Prototype V6 | 8 | 22.44 | 66.63 | 7 | 2.81 | ++ |

### Example 2

Comparison of Prototype with Chicken Egg

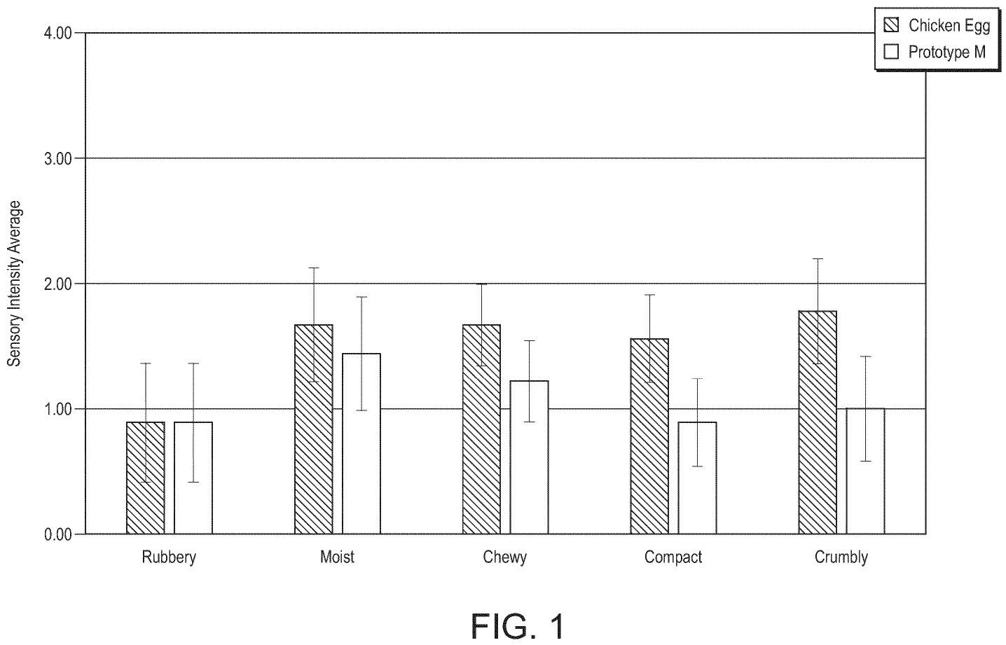

FIG. 1 shows a comparison of prototype M versus chicken egg when measured for texture by sensory assessment in scrambled egg application. Sensory data, acquired according to the methodology described in example 1, were processed with EyeOpenR® software (Logic 8, Elst, the Netherlands). The “LSD” (Least significant difference) is plotted to the bar charts to show a proxy of the panel intra variability. The confidence level was set to 5% (p-value <0.05). LSD bars overlapping signifies the prototype is not significantly different than chicken egg. Prototype M thus performs in a similar manner to chicken egg for the 5 attributes assessed.

### Example 3

### Correlation Between Particle Size, Oiliness, Firmness, Chewiness, Stickiness

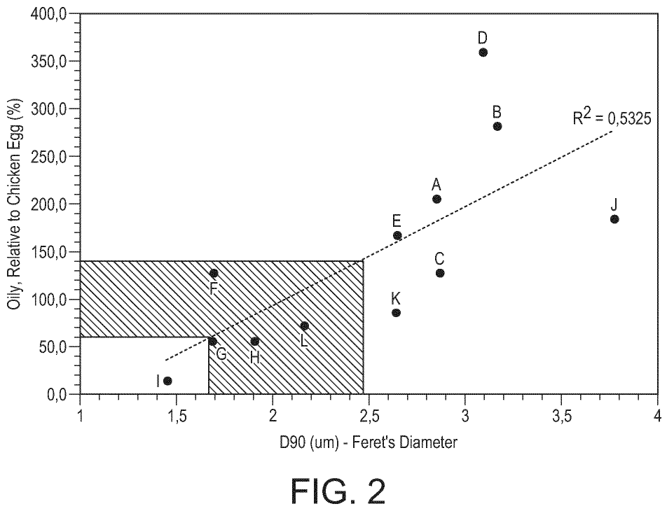

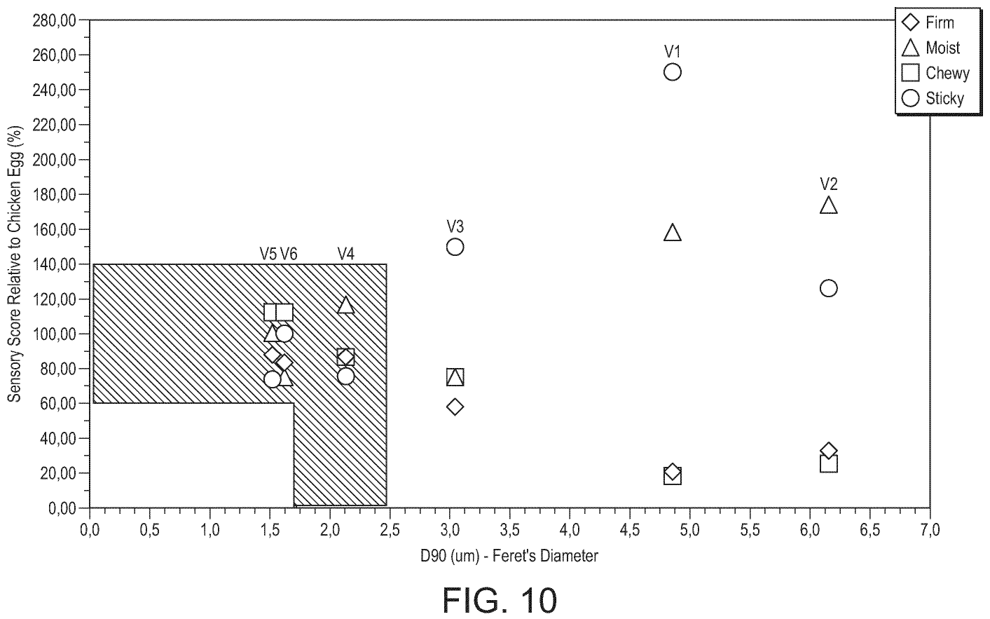

FIGS. 2 and 10 show the relationship between the D₉₀ of the particle size distribution of several soy protein-based emulsion prototypes, and their respective oiliness, firmness, chewiness, stickiness relative to that of chicken egg when cooked in scrambled egg application.

The prototypes were prepared according to example 1. The sensory parameters were determined by sensory analysis according to the sensory methodology described in example 1.

Optimal microscopy was performed on the uncooked emulsion prototypes at 40× magnification. Emulsions were diluted 20 times with reverse osmosis water and observed using optical microscopy (Axioplan I, Zeiss, Germany) in transmitted light and bright field mode. The images obtained were further analyzed to determine the size properties of the individual emulsion fat droplets.

Image analysis was performed using Image J software (National Institute of Health, USA). Due to the large numbers of samples, this process was automated through the use of macros set up within Image J. In total, between 450 particles (in prototype J) and 1489 particles (in prototype K) were measured.

For the measurement, the region of interest (ROI) was defined in order to detect particles. The background was subtracted from images using a ‘rolling ball’ algorithm before the threshold was applied and particles measured. To prevent any misrepresentative segmentation which can be caused from automatic detection, all segmentation results were visualized. The overlay was saved as a separate image that was manually inspected. Feret's diameter was measured for each particle detected which allowed to determine the particle size distribution of each prototype produced. The D₉₀ parameter was extracted and corresponds to the particle diameter at 90% in the cumulative distribution.

The results show that the prototypes have 60-100% of the texture of chicken egg for a D₉₀ between 1.7 and 2.5 um.

### Example 4

### Correlation Between pH and Firmness, Moist, Chewiness

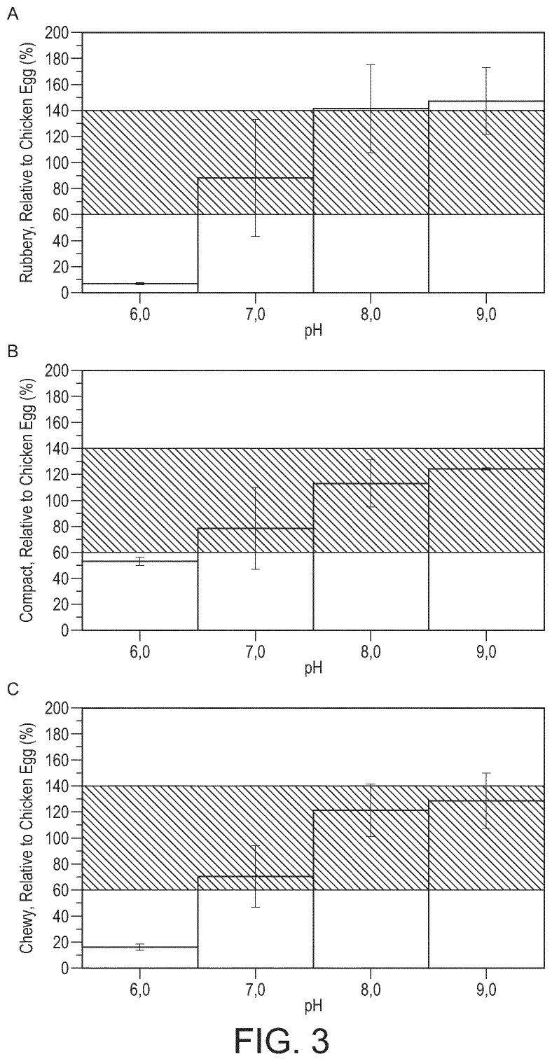

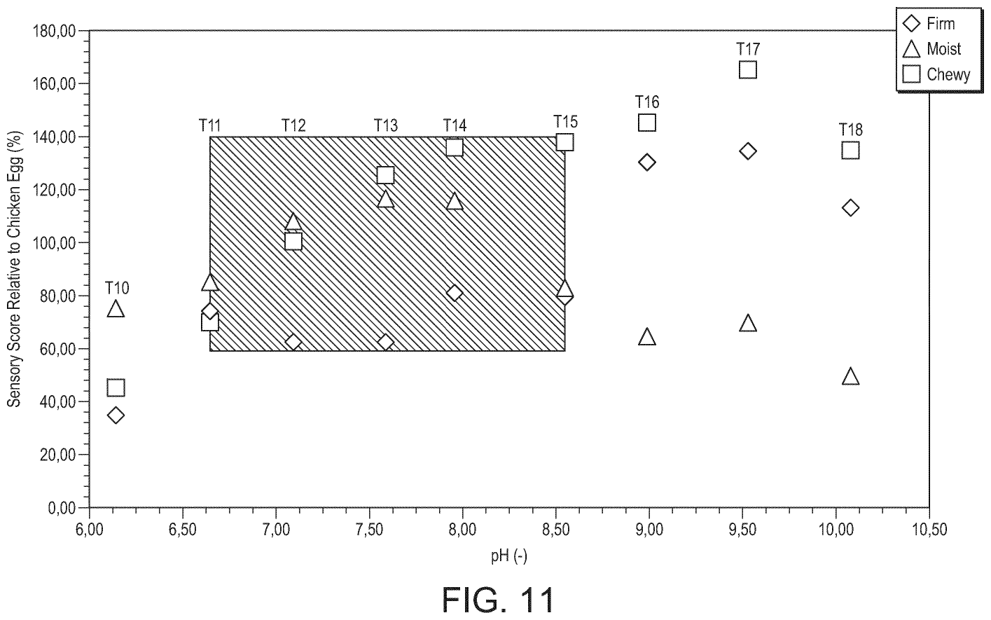

FIGS. 3 and 11 show the relationship between the texture parameter of several soy protein-based emulsion prototypes cooked into scrambled egg application and their pH. Rubbery, compact and chewy are depicted in FIGS. 3.A, 3.B and 3.C respectively and firm, moist and chewy in FIG. 11.

In FIG. 3, several prototypes covering different protein, fat and water composition with same pH are grouped as follows:

$$\begin{matrix}pH 6 = prototypes E , J ; \\ pH 7 = prototypes B , D , H , L ; \\ pH 8 = prototypes A , F , I , K ; \\ pH 9 = prototypes C , G .\end{matrix}$$

In FIG. 11, several prototypes of same composition but different pH varying from 6.1 to 10.1 (from T10 to T18) are represented.

Prototypes were produced and cooked according to the respective methods described in example 1. The texture parameters were determined by sensory analysis according to the method described in example 1. In FIG. 3, errors bars represent the standard deviation of the texture attributes for each pH groups.

The results show the prototypes have between 60-100% of the texture properties of the chicken egg for a pH between 7 and 9 in FIG. 3 and a pH 6.7 to 8.6 in FIG. 11.

### Example 4

### Heat Set Gelling Properties of Potato Protein Isolate

Dispersions of potato protein isolate were prepared using Milli-Q® water at a range of concentrations. To limit the amount of gas, the water was filtered under vacuum (Sartolab, 180C6, 0.22 μm PES). Protein powder was added slowly to the water while stirring with a magnetic stirrer. The pH was adjusted to 6.0 using 0.1 and 1M HCl or 1 M NaOH. The dispersions were kept at 4° C. overnight to ensure maximum hydration. Heat induced gelation was monitored using stress-controlled rheometers (Anton Paar MCR) equipped with a sandblasted concentric cylinder (27 mm). A thin layer of mineral oil was applied to prevent evaporation. The loss and storage modulus were measured at a frequency of 1 Hz and a strain of 0.5% while heating from 20° C. to 90° C. at a heating rate of 5° C./min, followed by 20 minutes holding at 90° C. and a subsequent cooling step from 90° C. to 20° C. at 4° C./min.

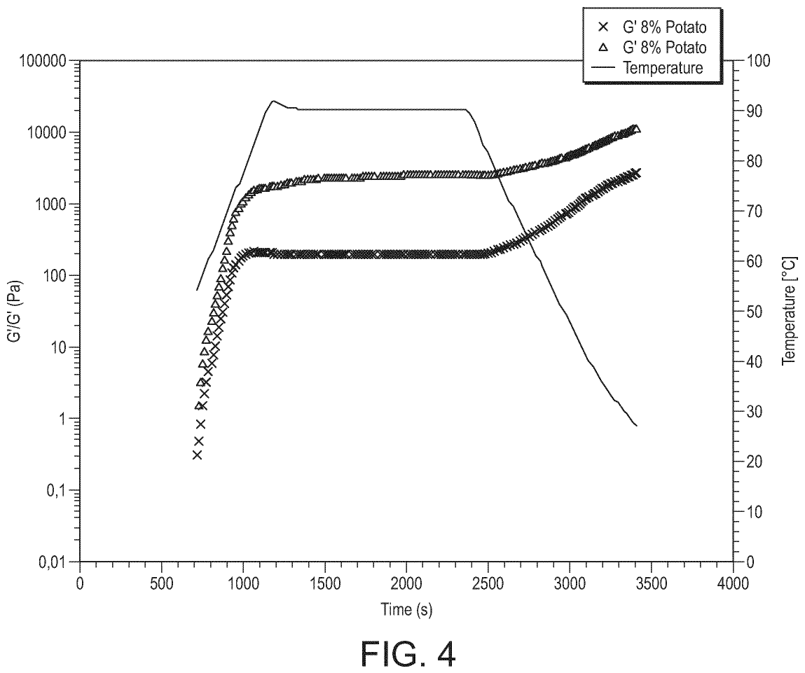

FIG. 4 shows the increase of G′ and G′ of the potato protein dispersion on heating by several orders of magnitude. At 45° C., the potato protein starts to unfold, causing the exposure of, hydrophobic groups which can interact, thereby forming a three-dimensional network with gel-like properties. This can already occur at the onset of protein denaturation as hydrophobic groups can be exposed even if the protein is not fully denatured. The elastic modulus (G′), which relates to the gel strength, increases as the junction zones between the protein molecules increases.

The figure shows the storage modulus (G′) for potato protein solution (8 w/w %) during heating/cooling ramps (increasing from 20° C. to 90° C. at 5° C./min, holding for 20 min at 90° C., decreasing from 90° to 20° C. at 4° C./min), at a constant strain of 0.5% and frequency of 1 Hz, within the linear viscoelastic region.

Potato protein can thus be used in combination with the described emulsion mixture to module the strength of the gel when cooked.

TABLE 3

| Potato protein | | G′ (Pa), T = | G″ (Pa), T = | G′ (Pa), T = | G″ (Pa), T = |
|---|---|---|---|---|---|
| concentration | | 60° C. | 60° C. | 90° C. | 90° C. |
| 6% | wt. | 1860 | 194 | 774 | 97 |
| 8% | wt. | 3751 | 443 | 2814 | 209 |
| 10% | wt. | 6015 | 768 | 4845 | 385 |
| 12% | wt. | 8552 | 1116 | 6845 | 686 |
| 14% | wt. | 18919 | 2282 | 15639 | 1115 |

Table 3 shows G′, G″ values for potato protein dispersion at a range of concentrations and temperatures, measured at a constant strain of 0.5% and frequency of 1 Hz, within the linear viscoelastic region.

### Example 5

Scrambled Egg Analogue Recipe with Improved Cooking Performance and Sensory Attributes Using Kappa-Carrageenan

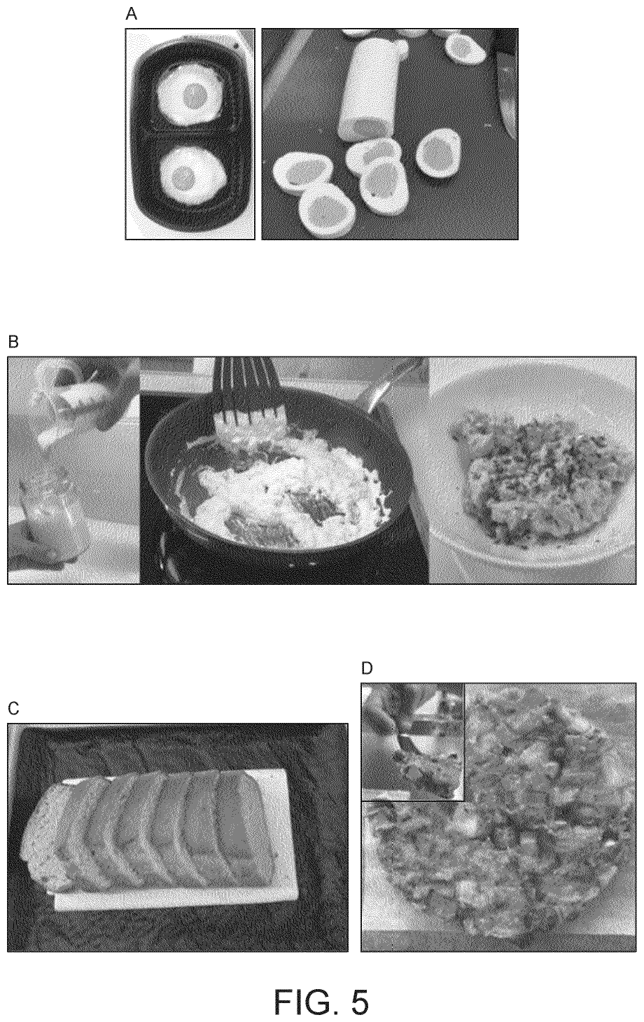

An egg analogue was produced according to the invention and the macronutrient table shown in table 4. The product had a liquid-like, pourable texture in cold conditions and during chilled storage. A scrambled egg was produced by cooking 100 g of the liquid product in a pan to between 90° C. and 100° C. (product temperature) for 2 minutes. The ability of kappa-carrageenan to bind water and increase the apparent viscosity of the continuous phase without destabilizing the emulsion mixture led to enhanced sensory properties of the product i.e. a closer match to cooked scrambled chicken egg compared to the product without added kappa-carrageenan. Moreover, the behaviour in the pan was improved in terms of reducing both bubbling effects and water loss throughout the cooking process. The liquid egg analogue is shown in FIG. 5 at three different stages: a. pourable liquid in chilled conditions; b. during cooking in a pan c. cooked, scrambled egg.

TABLE 4

| Liquid egg analogue with added | |
|---|---|
| kappa-carrageenan | g/100 g |
| Protein | 6.8 |
| Fat | 27.2 |
| Carbohydrates (kappa-carrageenan) | 0.05 |

Table 5 shows the composition of several soy-based emulsion prototypes used in several common egg applications (A, B, C, D).

TABLE 5

| | | | | | | Polysaccharides | | | |
|---|---|---|---|---|---|---|---|---|---|
| | | | | | | | kappa | Natural | Natural |
| Application | Figure | Protein | Fat | Water | Transglutaminase | Starch | carrageenan | flavor | colorant |
| Egg White | A | 7 | 29.6 | 61.7 | 0.1 | | | 0.4 | |
| analogue: | | | | | | | | | |
| sunny side- | | | | | | | | | |
| up / vegan | | | | | | | | | |
| tube | | | | | | | | | |
| Egg Yolk | A | 4.4 | 40.3 | 49.9 | 0.03 | 2.4 | | 0.5 | 2.1 |
| analogue: | | | | | | | | | |
| sunny side- | | | | | | | | | |
| up / vegan | | | | | | | | | |
| tube | | | | | | | | | |
| Egg analogue | B | 6.8 | 27.2 | 64.3 | | | 0.05 | | 0.6 |
| cooked as | | | | | | | | | |
| scrambled | | | | | | | | | |
| egg | | | | | | | | | |
| Egg replacer | C | 6.8 | 27.2 | 64.3 | | | | | 0.6 |
| used in egg- | | | | | | | | | |
| free cake | | | | | | | | | |
| Egg replacer | D | 7.4 | 29.6 | 62.1 | 0.1 | | | | |
| used as | | | | | | | | | |
| binder in | | | | | | | | | |
| Vegetable | | | | | | | | | |
| patty | | | | | | | | | |

A sunny side-up/egg tube was produced according to the invention and based on the macronutrient composition shown in table 5.

For the production of the egg white and egg yolk analogues, the process further included the steps of: crosslinking the protein with transglutaminase, moulding the egg yolk with the egg, heating to 40° C. for 30 min and heating to 90° C. for 30 min in a steam oven. For the yolk analogue, the starch was added before the heating step as described above. The final texture was similar to the cooked chicken egg. The product texture can be optimized allowing moulding in a tube shape and slicing into well-defined slices. FIG. 5A shows the sunny side-up and tube applications.

A liquid egg replacer for use in a cake was produced according to the invention and based on the macronutrient composition shown in table 5. The process further included mixing the liquid egg replacer with sugar, almond milk, wheat flour, baking powder, followed by moulding and cooking to 180° C. in an oven. The textural attributes of the final eggless cake was similar to that of the reference with chicken egg. FIG. 5C shows the egg-free cake product application.

A liquid egg replacer for use as a binder in vegetable burgers was produced according to the invention and based on the macronutrient table shown in table 5. The process further included mixing the liquid egg replacer with vegetables, spices and texturized protein, moulding into a burger shape, frying and cooking in oven. The egg analogue provided binding properties, retaining the burger shape during chilled storage and cooking. The gel strength provided by the egg replacer led to a firm bite similar to the chicken egg reference product.

### Example 6

Impact of Heat Applied to the Emulsion Prototypes at Pressure Greater than Atmospheric Pressure and by Steam Injection on Firmness, Moistness, Chewiness, Rubberiness, Compactness, Crumbliness and Stickiness.

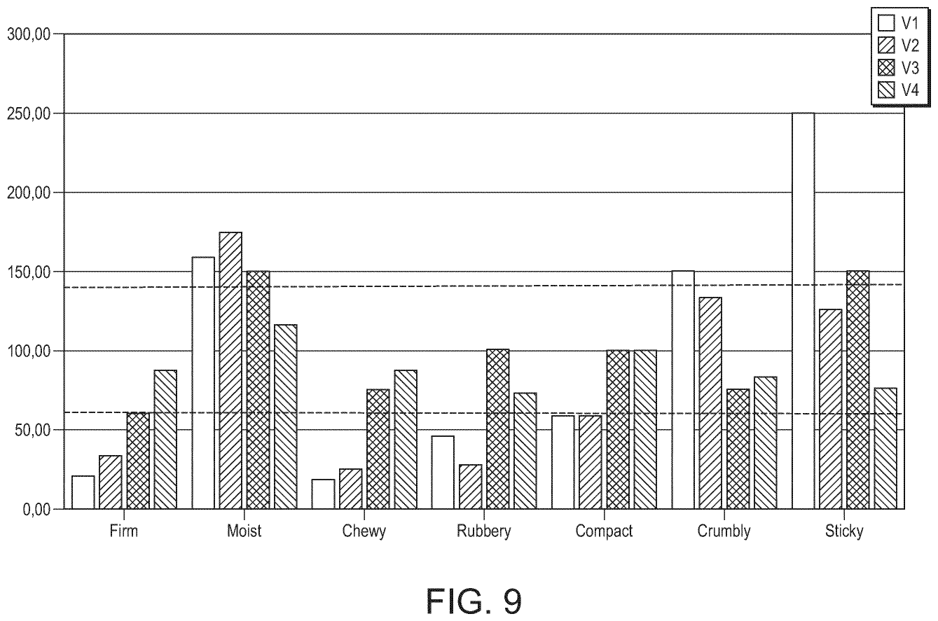

FIG. 9 shows the relationship between the heat treatment conditions applied to the prototypes and their respective firmness, moistness, chewiness, rubberiness, compactness, crumbliness and stickiness relative to that of chicken egg when cooked in scrambled egg application.

The prototypes were prepared according to example 1. The sensory parameters were determined by sensory analysis according to the sensory methodology described in example 1.

Table TX summarizes the differences between the protypes:

| | Heat treatment | Heat treatment | Downstream | |
|---|---|---|---|---|
| | T° C./time | Pressure (bars) | homogenization | |
| V1 | N.A. | N.A. | N.A. | |
| V2 | 91° C., 10 min | 1 (atmospheric) | N.A. | |
| V3 | 141° C., 5 sec | 6 | 0 | bar |
| V4 | 141° C., 5 sec | 6 | 30 | bars |

FIG. 9 shows that for the variant which was not heat treated by steam injection (V1), none of the 7 texture attributes falls within the 60-100% range of the sensory average intensity determined for the chicken egg reference.

For the variant which was heated at atmospheric pressure (V2), 5 out of 7 of the texture attributes fall out of the 60-100% range of the sensory average intensity determined for the chicken egg reference.

For the variant which was heated by steam injection at greater than atmospheric pressure (V3), only 2 of 7 texture attribute falls out of the 60-100% range of the sensory average intensity determined for the chicken egg reference.

Finally, for the variant which was heat treated by steam injection at greater than atmospheric pressure and that was subsequently homogenized (downstream homogenization) at 30 bars (V4), all of the 7 texture attributes fall within the 60-100% range of the sensory average intensity determined for the chicken egg reference. This downstream homogenization pressure enables achieving the D₉₀ required to reach the optimal texture properties.

### Example 7

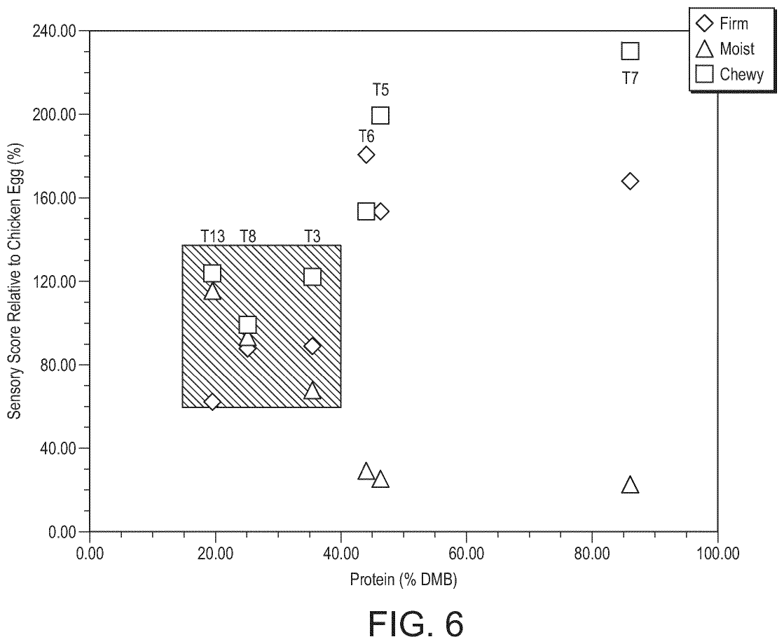

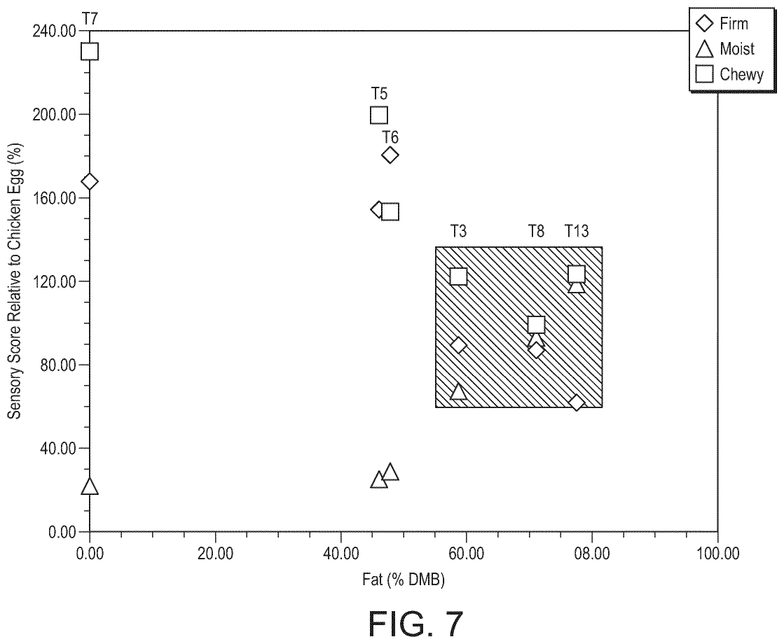

FIGS. 6 and 7 show the relationship between the protein content or fat content in % dry matter basis (% DMB) of several soy protein isolate-based emulsion prototypes (T3, T5 to T8 & T13) and their respective sensory attributes (firm, moist and chewy) relative to chicken egg when cooked in scrambled egg application.

The prototypes were prepared according to example 1. The firm, moist and chewy parameters were determined by sensory analysis according to the sensory methodology described in example 1.

The results show the prototypes have between 60 and 100% of the texture properties of chicken egg for a protein and fat content between 15 and 40% DMB and 58 and 81% DMB, respectively.

### Example 8

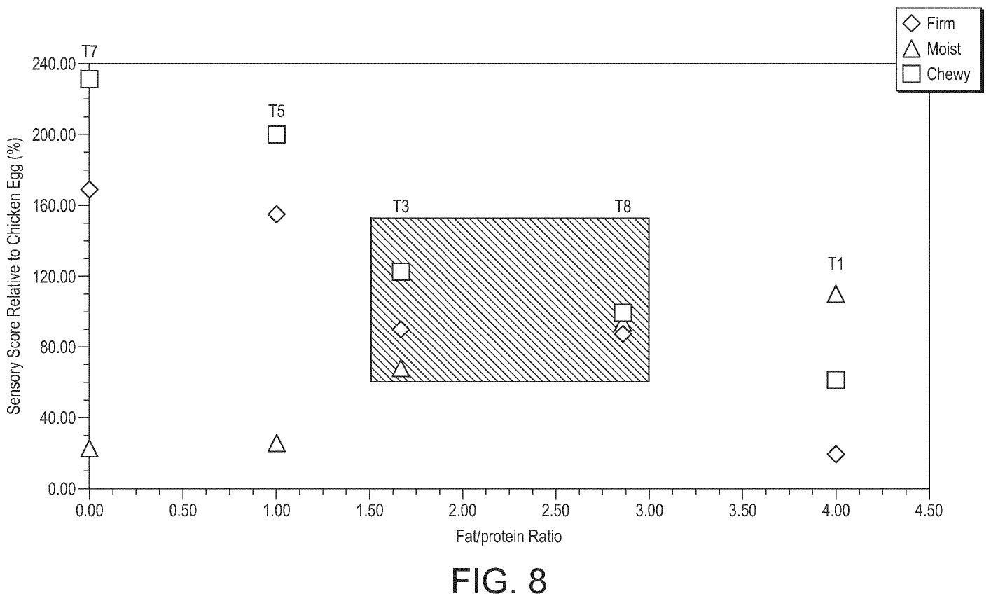

FIG. 8 shows the relationship between the fat to protein ratio of several soy protein isolate-based emulsion prototypes and their respective sensory attributes (firm, moist and chewy) relative to chicken egg when cooked in scrambled egg application.

The prototypes were prepared according to example 1. The firm, moist and chewy parameters were determined by sensory analysis according to the sensory methodology described in example 1.

The results show the prototypes have between 60 and 100% of the texture properties of chicken egg for a fat/protein ratio between 1.5 and 3.0.

1. A vegan egg analogue product, said product comprising an emulsion having between 10 to 43 wt. % legume protein on a dry basis, between 50 to 85 wt. % vegetable fat on a dry basis, and wherein said emulsion has a fat to protein ratio of between 1.2 to 8.5.

2. The product according to claim 1, wherein said emulsion has a fat to protein ratio of between 2.5 to 3.0.

3. The product according to claim 1, wherein the product has a pH range between 6 to 9.

4. The product according to claim 1, wherein the product has a D₉₀ emulsion droplet size less than 10 microns measured by image analysis.

5. The product according to claim 1, wherein the polysaccharide is a seaweed or a seaweed extract.

6. The product according to claim 1, wherein the polysaccharide is a carrageenan.

7. The product according to claim 1, wherein the polysaccharide is methylcellulose or a methylcellulose derivative.

8. The product according to claim 1, wherein the product comprises a plant protein having a G′ value between 3500 and 4000 Pa, and G′ value of between 400 and 500 Pa at 60° C. after heating to 90° C. at a protein concentration of 8% wt. measured at 1 Hz and 0.5% shear strain.

9. The product according to claim 1, wherein the product when cooked has between 60-100% of the texture attributes of a cooked egg.

10. The product according to claim 1, wherein the legume protein is a soy protein isolate.

11. A method of making a vegan egg analogue product, said method comprising
Hydrating a legume protein; and
Adding oil and emulsifying to form an emulsion.

12. A method of making an egg analogue product according to claim 11, comprising heating the emulsion to at least 50° C., adding methylcellulose and cooling the emulsion.

13. The method according to claim 11, wherein heat is applied to the emulsion at greater than atmospheric pressure.

14. The method according to claim 11, wherein heat is applied to the emulsion by steam injection.

15.-17. (canceled)
